(19) United States
(12) Patent Application Publication
(10) Pub. No.: US 2026/0194254 A1
(43) Pub. Date: Jul. 9, 2026

(54) CONNECTING SYSTEM FOR COMPONENTS FOR THE TEMPERATURE CONDITIONING OF A BUILDING

(71) Applicant: Envola GmbH, Ulm (DE)

(72) Inventors: Alexander SCHECHNER, Ulm (DE); Tim WAGNER, Ulm (DE)

(73) Assignee: Envola GmbH, Ulm (DE)

(21) Appl. No.: 19/128,320

(22) PCT Filed: Nov. 24, 2023
(86) PCT No.: PCT/EP2023/083030

§ 371 Date: May 8, 2025

(30) Foreign Application Priority Data
Nov. 25, 2022 (DE) 10 2022 131 288.7

(51) Int. Cl. F24F 13/00; F16L 41/03

(52) U.S. Cl. CPC F24F 13/00; F16L 41/03

(57) ABSTRACT

A connecting system for components for the temperature conditioning of a building, in particular for heating, cooling or air-conditioning of an interior, includes a base plate with openings which are formed in such a way that they can receive a connection element which is formed as an elongate hollow body along a longitudinal axis, wherein the longitudinal axis of the connection element is arranged perpendicular to the main surface of the base plate on a first side of the base plate, and each connection element has closable connection channels directed transversely with respect to the longitudinal axis, wherein at least one connection element is provided for each component, and the component is fluidically connected to a non-closed connection channel of its connection element, wherein a fluid connection to further components or as inlets or outlets is formed via a further non-closed connection channel.

The invention relates to a connecting system for components for the temperature conditioning of a building, in particular for heating, cooling or air-conditioning an interior.

It is generally known from the prior art that, as the seasons change, appropriate precautions must be taken to keep indoor temperatures within a comfortable temperature range for users. Different embodiments of heaters are used to increase the temperature, while lowering the temperature is often achieved by air-conditioning units, which feed outside air suitably cooled via a cooling compressor into the interior.

Modern systems are used as so-called air-conditioning systems, in which the outside air can be fed into the interior of the building as supply air via a heat exchanger by means of a radial fan. Exhaust air is often fed to the heat exchanger by means of an evaporative cooler, wherein the air sucked in by another radial fan leaves the building as exhaust air. In addition to various filters for cleaning the air, additional heaters can also be used to enable interior ventilation.

The systems described above usually interact with a heat pump installed in a building. Said heat pump can be supplied with electrical energy, for example, via the power grid or its own power storage system.

A further application example is the device for energy transmission and energy storage in a liquid reservoir described in DE 10 2019 118 223 A1, which comprises a water heat exchanger arranged on a base, wherein it is arranged in a liquid reservoir surrounded by an inner shell which delimits the device with respect to an outer shell covering the inner shell from the base, wherein the outer shell can be at least partially introduced into a ground layer, wherein the device comprises an air heat exchanger arranged above the water heat exchanger and wherein the device is closed upward by a cover in such a way that an air flow from an air inlet to an air outlet can be generated through the air heat exchanger.

When installing such air-conditioning systems, different hydraulic components are required, such as pumps, valves, temperature or pressure sensors, through which a fluid flows and which must be connected to each other in different ways. For this purpose, it is known to form detachable pipe connections in the form of screw or flange connections, pipe connections in the form of press fittings or rigid pipe connections by soldering or welding. The hydraulic components are usually attached to a wall surface and connected by means of a suitable pipe connection. Due to the different component connections, the number of required connections and the different sizes of the components, a conventional installation is often complex or requires a lot of installation space.

CN 111 457 448 B describes a manifold for water supply installed between a first lateral connecting part and a second lateral connecting part, wherein the first lateral connecting part and the second lateral connecting part are provided on a wall surface or a base surface, comprising a central pipe having a water supply nozzle formed at one end, wherein the other end is closed, a plurality of distribution sockets provided in a multitude of through holes formed in a side portion of the central pipe in order to be connected to the multitude of branch pipes.

DE 196 37 575 B4 describes a distribution station for a heater system, in particular for distributing hot water to operate a hot water heating system, having a first branch which is constructed from a plurality of uniform pipe elements which are each screwed together and in which a jet pump is arranged, wherein each pipe element is provided with an internal thread at one end and with an external thread at the opposite end which matches the internal thread, and has lateral nozzles, the central axes of which are arranged at equal distances from one another.

Against this background, the object is to create a connecting system for components for air-conditioning a building, which can be more compact and is associated with lower installation costs than previous systems.

This object is achieved by the features of claim 1. Further advantageous embodiments of the invention are the subject matter of each of the dependent claims. They can be combined with one another in a technically meaningful manner. The description, in particular in conjunction with the drawing, additionally characterizes and specifies the invention.

According to the invention, a connecting system for components for the temperature conditioning of a building, in particular for heating, cooling or air-conditioning of an interior, is created, wherein the connecting system comprises a base plate which is provided with a plurality of openings which are formed in such a way that they can receive a connection element which is formed as an elongate hollow body along a longitudinal axis, wherein the longitudinal axis of the connection element is arranged perpendicular to the main surface of the base plate on a first side of the base plate, and each connection element has a plurality of closable connection channels directed transversely with respect to the longitudinal axis, wherein at least one connection element is provided for each component, and the component is fluidically connected to a non-closed connection channel of its connection element to form a fluid connection to further components or an inlet or outlet of fluid via a further non-closed connection channel.

Accordingly, in the connecting system according to the invention, the region intended for installation is first covered with the base plate. The base plate can be arranged similarly to a side wall on a frame of an air-conditioning device, so that the base plate acts as an interface between the air-conditioning device and the outside world. The individual components are connected to the base plate via one or more connection elements. However, in addition to this holding function, the connection elements also fulfill another function by forming a fluid connection to other components or an inlet or outlet for the fluid. When it comes to hydraulic components in air-conditioning technology, the fluid is typically a working medium such as air, water or mixtures of different liquids that are required to operate, for example, a heat pump. The dual function of the connection elements as a holder and fluid connection results in a clear, compact and, moreover, maintenance-friendly structure. The connecting system according to the invention can moreover be easily modified in case of changes, for example changes in the air-conditioning system performance requirements, so that an existing installation can be expanded or supplemented. The openings in the base plate for accommodating the connection elements can be arranged in a regular pattern, wherein in addition to the positions actually occupied by connection elements, additional openings can also be provided for later extensions. Alternatively, a perforated plate can be used for example, which is provided with openings preferably arranged in a pattern.

According to one embodiment of the invention, the connection channels of the connection element are designed as internal thread connections in side walls of the connection element.

In this way, it is possible to lead the components to be connected or the inlets and outlets, respectively, directly into the side walls of the connection element via a corresponding external thread to form a threaded connection, which can also be provided with seals.

According to a further embodiment of the invention, the connection element is designed as a hollow cylinder which is provided with flat surfaces at the internal thread connections.

The design with flat surfaces makes it possible to insert a variety of shaped external thread connections for fastening the components into the internal thread of the connection element and, for example, to provide them with an additional seal in the region of the flat surfaces. The fluid can then pass through the hollow cylinder and reach the connection channels.

According to a further embodiment of the invention, connection channels of the connection element are arranged in several planes along the longitudinal axis, each of which has connection elements rotated by 90° and aligned to be flush with one another.

In this way, a regular structure of the connection elements can be achieved, in which the connection channels moreover point in defined directions.

According to a further embodiment of the invention, further, shortened connection elements are provided which have a spacer in the region of the plane of the connection elements facing the base plate.

The shortened connection elements are hence designed such that fluid connections can be passed underneath them in the region of the spacer. The remaining design of the shortened connection elements is identical to the connection elements already described above. This makes it possible to arrange connection elements and shortened connection elements on the base plate, wherein the shortened connection elements can be mounted between connection elements, for example, via already installed fluid connections or can be provided to save space. The spacer can, for example, be designed as a C-profile, wherein the side facing the shortened connection element also provides a seal with respect to the hollow cylindrical structure of the shortened connection element.

According to a further embodiment of the invention, the connection channels are provided with a pipe connection, preferably in the form of a press fitting or flange connection, via which a pipe connection to the component or to another connection element is formed.

Until now, the connection between hydraulic components and a connection element and between connection elements has only been generally described as a fluid connection. Since hydraulic components are typically supplied by a variety of different manufacturers, there is no standardized connection on the components that could be integrated into the connecting system according to the invention. It is therefore intended to provide the connection channels with a pipe connection via which the connection to the component or to other connection elements is formed. A pipe connection can, for example, be designed in the form of a press fitting or flange connection, wherein other types of connection should not be excluded. In order to connect a component to a connection element, a press fitting is screwed into the connection channel of the connection element, for example. A plastics pipe of appropriate length is then pressed into the press fitting. The other end of the plastics pipe is connected to the component, wherein different connection techniques can be used here, which follow the design of the component connection. If the component has a second or further component connections, they are also connected accordingly with a connection element. In this way, it is also possible to create inlets and outlets, respectively, for fluid lines.

According to a further embodiment of the invention, the orientations of the pipe connections toward other connection elements are selected in the form of a cross-free pipe routing for the individual planes.

This makes it possible to create connections between different connection elements using a fluid flow plan. The procedure can be similar to that used for printed circuit board routing, for example, by preferably selecting only one orientation of pipe connections for each plane.

According to a further embodiment of the invention, the connection channels of the connection elements that are not required are closed by means of screwable closure plugs.

By means of the closure plugs, it is possible, for example, to open previously unused connection channels for additional applications after the initial installation in order to create connections for additional components via pipe connections. It is thus possible to respond flexibly to change requests. Furthermore, it is possible to close the hollow cylindrical interior of the connection elements by means of union nuts arranged on the second side of the base plate, which at the same time ensure a stable fastening of the connection elements on the base plate.

According to a further embodiment of the invention, the connection elements are made of plastics material.

This enables cost-effective production of the connection elements, which can be pre-produced in large quantities and in different sizes as a modular system, without having to provide individually manufactured parts for installation.

What is furthermore described is the use of a connecting system as specified above in a device for air-conditioning a building.

Some exemplary embodiments are explained in greater detail below with reference to the drawing. In the drawings:

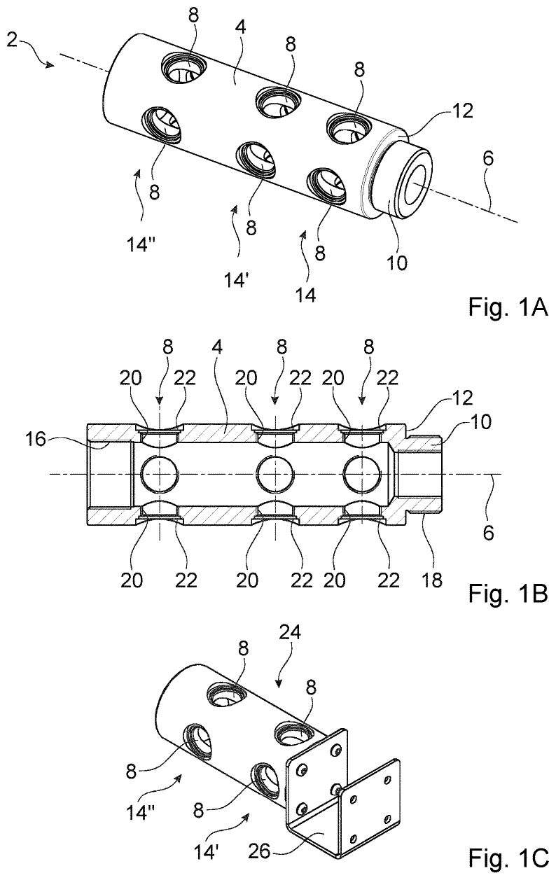

FIG. 1A shows a schematic perspective side view of a detail of a connecting system according to the invention,

FIG. 1B shows a sectional view through FIG. 1A,

FIG. 1C shows a schematic perspective side view of a further detail of a connecting system according to the invention,

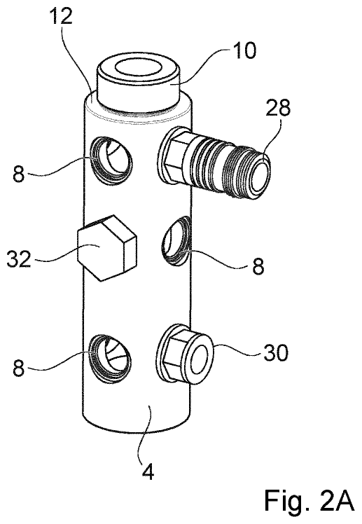

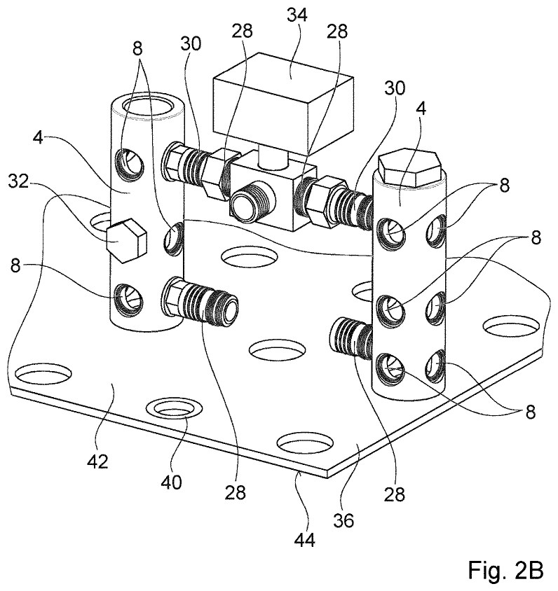

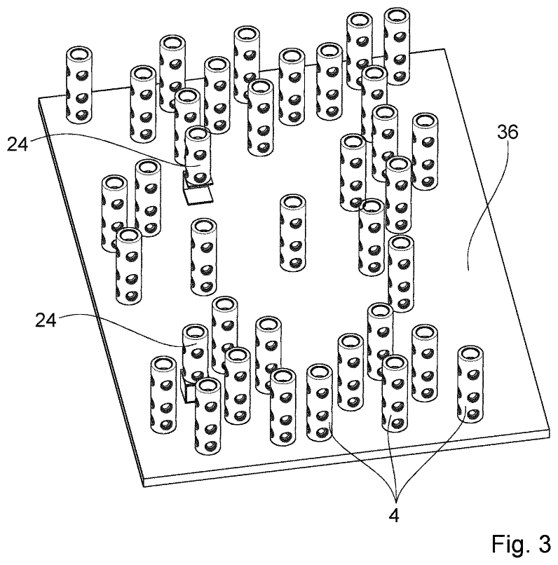

FIG. 2A shows a schematic side view of a further detail of a connecting system according to the invention,

FIG. 2B shows a schematic side view of a further detail of a connecting system according to the invention,

FIG. 3 shows a perspective side view of a connecting system according to the invention,

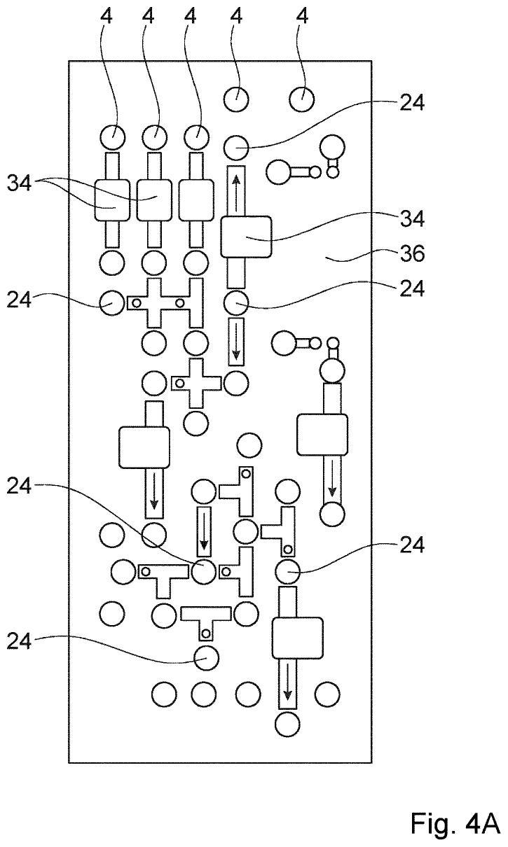

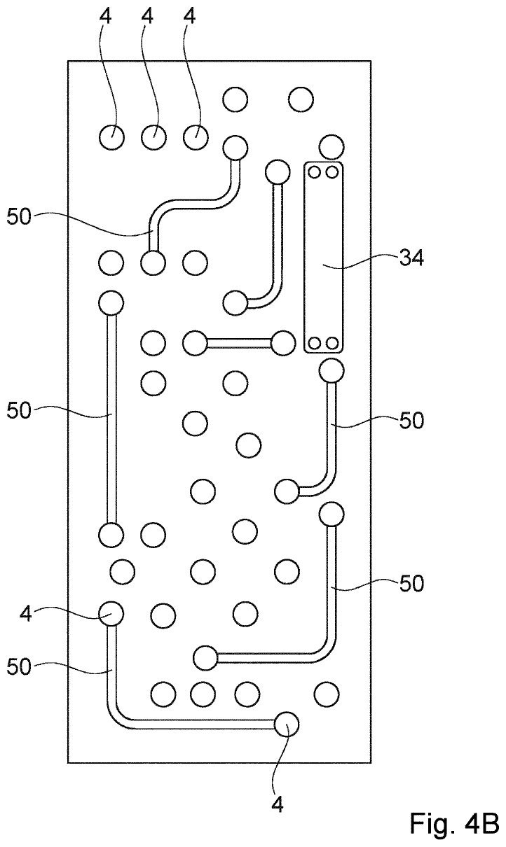

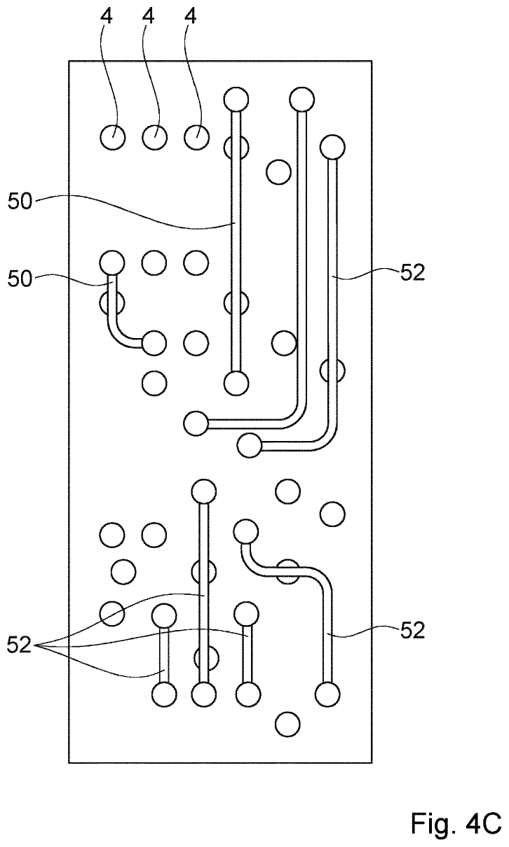

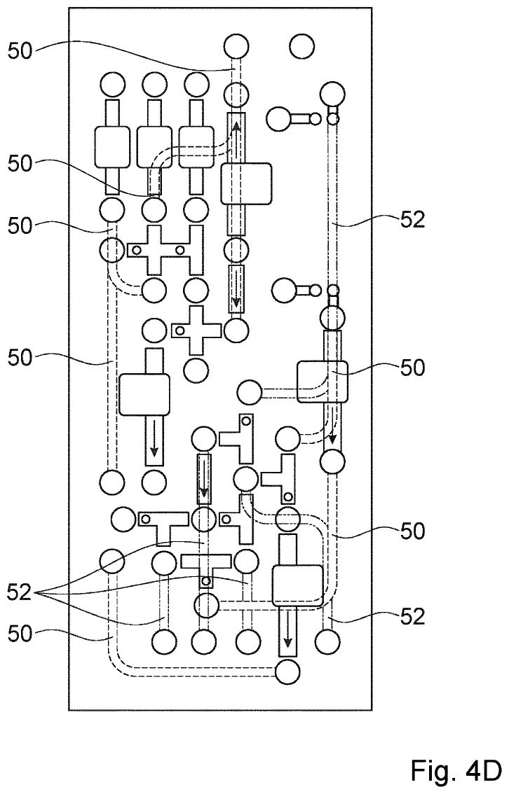

FIG. 4A shows a schematic top view of part of a connecting system according to the invention,

FIG. 4B shows a schematic top view of part of a connecting system according to the invention,

FIG. 4C shows a schematic top view of part of a connecting system according to the invention, and

FIG. 4D shows a schematic top view of part of a connecting system according to the invention.

In the figures, the same or functionally equivalent components are provided with the same reference signs.

FIG. 1A shows a perspective side view of a first embodiment of a component part of a connecting system 2 according to the invention. This component part is a connection element 4, which is designed as an elongated hollow body formed along a longitudinal axis 6. The connection element 4 has several connection channels 8 transverse to the longitudinal axis 6.

On one end face of the connection element 4 there is a cylindrical extension 10 which has a smaller diameter than the hollow cylindrical connection element 4. The support surface 12 created in the transition region is used to fasten the connection element 4 to a base plate. For this purpose, an external thread (not shown in FIG. 1A) can be provided along the outer circumference of the extension 10, so that a fastening can be created via the support surface 12 of the connection element 4 on the base plate using a nut or the like.

The individual connection channels 8 are arranged relative to the support surface 12 in several parallel planes, which in FIG. 1A are designated by reference signs 14, 14′and 14″. The connection channels 8 of one plane are rotated by 90° relative to one another, wherein the connection channels 8 of each plane 14, 14′and 14″ are aligned to be flush with one another, so that all centers of the connection channels are arranged along a line parallel to the longitudinal axis 6.

FIG. 1B shows a sectional view of the connection element 4 of FIG. 1A. Several threaded connections can be formed to close the hollow cylindrical connection element 4. Thus, in the region of ends opposite the extension 10, an internal thread 16 is provided, via which a locking screw can be guided into the connection element 4 in order to close it at this point.

In the region of the extension 10, a union nut could be used, which is fastened to the external thread 18 and holds the connection element 4 together with the support surface 12 to a base plate. Alternatively, an internal thread opposite to the external thread 18 could be used, into which a locking screw can be inserted. The connection element 4 would then be fastened with a nut on the external thread 18.

The connection channels 8 are furthermore each provided with an internal thread connection 20. Pipe connections can be inserted into the internal thread connection 20, as explained further below. For this purpose, flat surfaces 22 are provided on the outside of the connection element 4 for each connection channel 8, which can be used as contact surfaces for the pipe connection.

A further embodiment is shown with reference to FIG. 1C. FIG. 1C shows a perspective side view of shortened connection elements 24. Instead of the extension 10 and the connection channels 8 in the region of the first plane 14, the shortened connection element 24 has a spacer 26 at this point, which bridges the region between the shortened connection element 24. In this way, it is possible for further connection elements 4, which are connected to one another via a pipe connection via connection channels 8 in the first plane 14, to be placed so that the shortened end element 24 bridges the region of the pipe connections via the spacer 26.

FIG. 2A shows the use of the connection element 4 by way of example. To fasten a pipe connection, several pipe connections are provided, wherein one pipe connection is designed as a press fitting 28 and one pipe connection as a flange connection 30. Both the press fitting 28 and the flange connection 30 can be connected either to further connection elements 4 or to a component. Unused connection channels 8 are closed with a closure plug 32, which is designed in the form of a screw herein.

The connection of a component 34 is shown with reference to FIG. 2B. Here, the connection elements 4 are placed on a base plate 36. The flange connection 30 in the connection channel of the connection element 4 on the second plane 14″ is connected to corresponding flange connections 38 and a pipe connection, so that the component 34 is fluidically connected to the two connection elements 4 via these pipe connections.

The extensions 10 of the connection elements 4 are inserted into the openings 40 of the base plate 36 from the first side 42 and serve to hold them in the base plate 36. From the second side 44, the connection elements 4 can be secured by means of a union nut (not shown).

The openings 40 in the base plate 36 for accommodating the connection elements 4 can be arranged in a regular pattern, wherein in addition to the positions actually occupied by connection elements 4, additional openings 40 can also be provided for later extensions. Alternatively, a perforated plate can be used for example, which is provided with openings 40 preferably arranged in a pattern.

Referring to FIG. 3, an embodiment of the invention is shown by means of which a more complex system is constructed. A plurality of connection elements 4 or shortened connection elements 24 are provided on the base plate 36, which are inserted into openings in the base plate 36 via their respective extensions. Each connection element 4 or each shortened connection element 24 can now be assigned an inlet or outlet of a pipeline as well as a component element by providing the corresponding opening of the connection channel with a pipe connection, as described above.

The hose lines formed by pressing or screwing are then placed in the different planes of the connection elements 4 or 24 in order to achieve the desired functionality. The pipelines are preferably laid in such a way that each pipeline runs in one plane without crossing other pipelines. In this way, no U-shaped bypasses of a pipeline need to be provided.

The structure of a complex system is explained again using FIG. 4A to 4D by way of example. FIG. 4A corresponds to a top view of the base plate 36 with a multitude of components 34 and connection elements 4 and 24, respectively.

In FIG. 4B and FIG. 4C, respective pipe connections 50 are shown in one plane and further pipe connections 52 are shown in a plane below. FIG. 4C also shows the function of the shortened connection elements 24. The pipe connections 52 can pass the connection elements 24 in the region of the spacer 26 here.

The result is a complex arrangement of hydraulic components 34 with their pipe connections 50 and 52, as shown in FIG. 4D as an overlay of FIG. 4A to 4C. When planning such an arrangement, one can proceed similarly to a circuit diagram of a printed circuit board, in which the pipe connections 50 and 52 are selected with regard to their orientation in such a way that an identical orientation of the pipe connections 50 and 52 is preferably selected for each plane. The components 34 can be different hydraulic components, such as pumps, sensors or valves.

The features indicated above and in the claims, as well as the features which can be seen in the figures, can advantageously be implemented both individually and in various combinations. The invention is not limited to the described exemplary embodiments, but can be modified in many ways within the scope of the capabilities of a person skilled in the art.

### List of Reference Signs

2 Connecting system
4 Connection element
6 Longitudinal axis
8 Connection channel
10 Extension
12 Support surface
14 Plane
14′ Plane
14″ Plane
16 Internal thread
18 External thread
20 Internal thread connection
22 Flat surfaces
24 Shortened end element
26 Spacer
28 Press fitting
30 Flange connection
32 Closure plug
34 Component
36 Flange connection
36 Base plate
38 Flange connection
40 Opening
42 First side
44 Second side
50 Pipe connection
52 Pipe connection

1. A connecting system for components (34) for the temperature conditioning of a building, in particular for heating, cooling or air-conditioning of an interior, which comprises a base plate (36) which is provided with a plurality of openings (40) which are formed in such a way that they can receive a connection element (4) which is formed as an elongate hollow body along a longitudinal axis (6), wherein the longitudinal axis (6) of the connection element (4) is arranged perpendicular to the main surface of the base plate (36) on a first side (42) of the base plate (36), and each connection element (4) has closable connection channels (8) directed transversely with respect to the longitudinal axis (6), wherein at least one connection element (4) is provided for each component (34), and the component (34) is fluidically connected to a non-closed connection channel (8) of its connection element (4), wherein a fluid connection to further components (34) or as inlets or outlets is formed via a further non-closed connection channel (8).

2. The connecting system according to claim 1, wherein the connection channels (8) of the connection element (4) are designed as internal thread connections (20) in side walls of the connection element

3. The connecting system according to claim 2, wherein the connection element (4) is designed as a hollow cylinder which is provided with flat surfaces (22) on the internal thread connections (20).

4. The connecting system according to claim 2, wherein the connection channels (8) of the connection element (4) are arranged in several planes (14, 14′, 14″) along the longitudinal axis (6), each having connection channels (8) rotated by 90°and aligned to be flush with one another.

5. The connecting system according to claim 1, wherein further, shortened connection elements (24) are provided, which have a spacer (26) in the region of the plane (14) of the connection elements (4) facing the base plate (36).

6. The connecting system according to claim 1, wherein the connection channels (8) are provided with a pipe connection, preferably in the form of a press fitting (28) or flange connection (30), via which a pipe connection (38) to the component (34) or to another connection element (4) is formed.

7. The connecting system according to claim 1, wherein the orientations of the pipe connections toward other connection elements (4) are selected in the form of a cross-free pipe routing for the individual planes (14, 14′, 14″).

8. The connecting system according to claim 1, wherein the connection channels (8) of the connection elements (4) which are not required are closed by means of screwable closure plugs (32).

9. The connecting system according to claim 1, wherein the connection elements (4) are made of plastics material.

10. A use of a device for air-conditioning a building comprising the connecting system (2) according to claim 1.
